(19) United States
(12) Patent Application Publication
(10) Pub. No.: US 2006/0137416 A1
(43) Pub. Date: Jun. 29, 2006

(54) Lock core reinforced structure device with two different metallic parts

(76) Inventor: Wen-Kwei Chang, Ping Tung Hsien (TW)

Correspondence Address: LEONG C LEI, PMB # 1008, 1867 YGNACIO VALLEY ROAD, WALNUT CREEK, CA, 94598, US

(21) Appl. No.: 11/020,363

(22) Filed: Dec. 27, 2004

(51) Int. Cl. E05B 15/16; E05B 17/00

(52) U.S. Cl. 70/417

(57) ABSTRACT

A lock core reinforced structure device with two different metallic parts comprises a lock sleeve, a revolver and a gate. The lock sleeve provides disposition and combination of the revolver and includes some pin holes providing disposition of upper pinballs, springs and a stop pin. The revolver includes a key channel for insertion of a key and some pin holes providing disposition of lower pinballs. Additionally, the main body of the revolver is made of two different metallic materials combined together, where the front part of it is made of easily machined cast iron or copper and the rear part of it is made of steel material or heat treatment reinforced steel which has more structure strength. Furthermore, a gate room is formed beside an open end of the key channel and provides disposition of a gate and a spring, which is sealed and fixed by a keyhole cover. The gate is constantly pushed by the spring and moves upward to seal the open end of the key channel.

### BACKGROUND OF THE INVENTION

(a) Technical Field of the Invention

The present invention relates to a lock core reinforced structure device with two different metallic parts, and more particularly, to a device with a revolver inside a lock sleeve, which both have basic structures like pinballs and key channels. The main body of the revolver is made of two different metallic materials combined together, where the front part of it is made of cast iron or copper, which is easily machined, and the rear part of it is made of steel, which has more strength. Because the rear part of the revolver is strong enough with the steel material, burglars are not able to poke open the lock core and steal money.

The present invention comprises a lock sleeve, a revolver and a gate. The lock sleeve includes an axial hole, where the revolver is able to be inserted into and rotate inside axially; some pin holes perpendicular and connected to the axial hole providing disposition of upper pin balls, springs and a stop pin; and a cover to seal and fix these pins balls, springs and the stop pin. The revolver includes a key channel with an open end, where a key is able to be inserted into, rotating the revolver and unlatching the lock core; some pin holes perpendicular and connected to the key channel, corresponding to the pin holes of the lock sleeve, providing disposition of lower pin balls; and an arc-concaved groove formed at the end, providing insertion of the stop pin to combine the revolver with the lock sleeve through the axial hole and to limit the revolver rotation angle. Additionally, the revolver is made of two different metallic materials, where the front part of it is made of cast iron or copper which is easily machined and the rear part of it is made of steel material or heat treatment reinforced steel which has more strength. Furthermore, a gate room is formed beside the key channel providing disposition of a gate and a spring, which is sealed and fixed by a keyhole cover combined at the open end of the revolver. The gate always seals the key channel of the revolver by the constant push of the spring, in order to prevent from intrusion possibilities of foreign bodies or rain.

(b) Description of the Prior Art

According to Taiwan Patent Publication No. 506456, a lock core structure improvement of a lock device comprises a fixation body, a revolver, a set of lock pins and a stopper sheet. The revolver disposed in the fixation body is able to rotate and comprises through holes providing disposition of ring-grooved pins and springs of the lock pin sets; a keyhole providing insertion of a surface-concaved key which pushes lock pins upward to open the lock; and an insertion hole formed at one side of it providing the insertion of the stopper sheet which includes two rooms at its both ends to contain springs. Diameters of the stopper springs are larger than the thickness of the stopper sheet. Additionally, two arc grooves are formed on upper and lower surfaces of the revolver corresponding to both ends of the stopper sheet, but they do not extend to the through hole and form a vertical wall to stop the stopper spring. Several stopper grooves are formed in the inner surface of the fixation body to stop and hold the stopper sheet. Accordingly, a lock device with multi-section lock core is formed.

Meanwhile, according to Taiwan Patent Publication No. 590139, a burglarproof lock core structure comprises primarily a cylindrical sleeve and a cylinder inserted therein, where upper pin rooms and lower pin rooms are formed and interconnected providing disposition of several sets of lower pins, upper pins and springs sequentially. In addition, one end of the cylinder forms a lock hole, providing insertion of a key. An arc rail is formed between the lock hole inside and the lower pin room of the cylinder in order to form at least an arc surface deviating from the lock hole center in one side. Cone endpoints of the lower pins extend outside the lower pin rooms and line up along the surface edge of the lock hole. The length of the cone endpoints sequentially converges direct to the arc surface. The main feature is that a control valve with a cone endpoint is formed corresponding to the other end of the arc surface of the lock hole so that a key with arcs corresponding to above-described arc rail, and pits corresponding to each lower pin and the cone endpoint of the control valve is required to open the lock.

Thus, the lock core structures of the prior arts have these special mechanism designs that are not easy to be poked open in order to reach the purpose of preventing from the burglar. However, no matter how complex or special the lock core mechanism designs are, burglars are always able to think of a corresponding way to destroy the lock core mechanism and succeed stealing money.

Recently, some said burglars destroy the lock core structure of the mail box lock and steal the letters, documents, checks, credit cards and financial cards. The main reason is that the lock core in the mail box lock is generally made of easily machined cast iron or copper material so that its structure is weak and does not have enough strength to defend the destroy by the external force from the burglars. Thus, the burglar can easily destroy the lock core structure of the mail box lock by a higher strength tool and succeed opening the lock and stealing money.

### SUMMARY OF THE INVENTION

The primary purpose of the present invention is to not only facilitate the machining of the lock core, but also to enhance the lock core structure strength by two different metallic parts combined together. Eventually, the reinforced structure of the lock core is not easily destroyed by external force and reaches the burglarproof purpose.

Embodiments of the present invention are described in detail by following reference figures.

At first, as shown in FIG. 1, the present invention comprises a lock sleeve 1, a revolver 2 and a gate 3.

The lock sleeve 1 comprises an axial hole 11 where the revolver 2 is inserted into and is able to rotate inside axially.

The lock sleeve 1 also comprises some pin holes 12 perpendicular and connected to the axial hole 11, where upper pin balls 13, springs 14 and a stop pin 15 are disposed in, and then a cover 16 is inserted to seal and fix these pins balls, springs and the stop pin.

The revolver 2 comprises a key channel 21 inside with one open end, where a key can be inserted into, rotating the revolver 2 and unlatching the lock core.

The revolver 2 forms a gate room 28 beside the open end of the key channel 21, providing disposition of a gate 3 and a spring 31, where a keyhole cover 32 then seals the open end of the revolver 2. The gate 3 usually seals the key channel 21 of the revolver 2 by the constant push of the spring 31, in order to prevent the key channel 21 from the intrusion possibilities of foreign bodies or rain.

The revolver 2 also comprises some pin holes 22 perpendicular and connected to the key channel 21, corresponding to the pin holes 12 of the lock sleeve 1, where lower pinballs 23 are disposed in.

The revolver 2 also forms an arc-concaved groove 24 at the end, providing insertion of the stop pin 15 to combine the revolver 2 with the lock sleeve 1 through the axial hole 11 and to limit the rotation angle of the revolver 2 inside the axial hole 11 of the lock sleeve 1.

Accordingly, the present invention specially relates to the subject of the lock core, being easily destroyed by external force, and further to the lock core structure improvement, comprising two metallic parts with firmed strength.

Additionally, the revolver 2 is made of two different metallic materials, where the front part of it is made of cast iron 25 or copper, which is easily machined, and the rear part of it is made of steel material 26 or heat treatment reinforced steel which has more strength. Furthermore, a pin 27 is inserted between the front part case iron 25 and the rear part steel 26 to combine and fix both parts, or a metal melting technology is applied to the joint surfaces of the cast iron 25 and the steel 26 to combine and fix the two different metallic parts in one unity.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of the present invention;

FIG. 2 is a cross-sectional view, illustrating inside structure of the present invention;

FIG. 3 is a cross-sectional view taken along line 3-3 of FIG. 2;

FIG. 4 is a cross-sectional view taken along line 44 of FIG. 2;

FIG. 5 is a schematic view, illustrating the structure of the key inserted in the key channel according to FIG. 4.

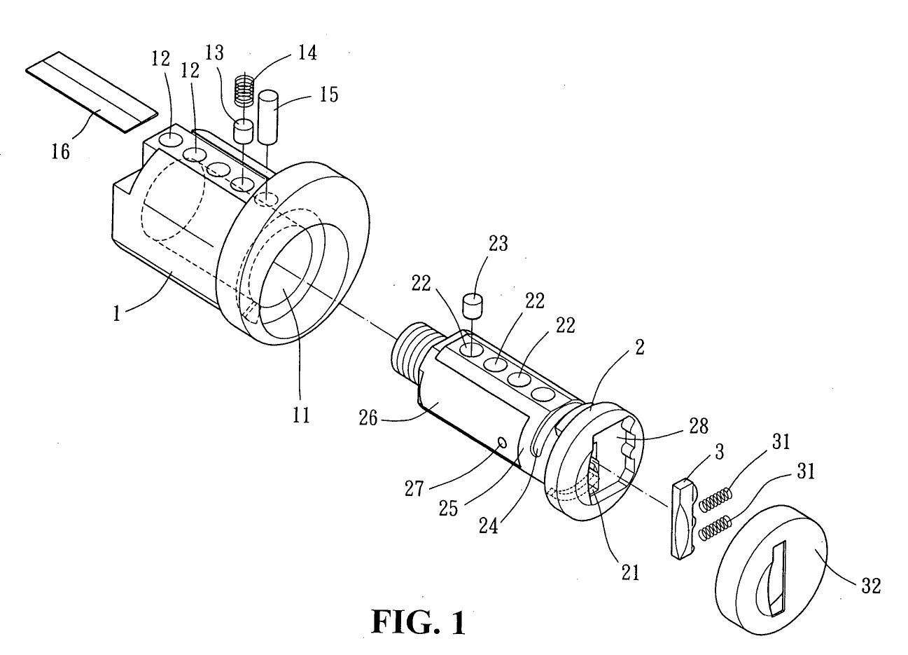

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

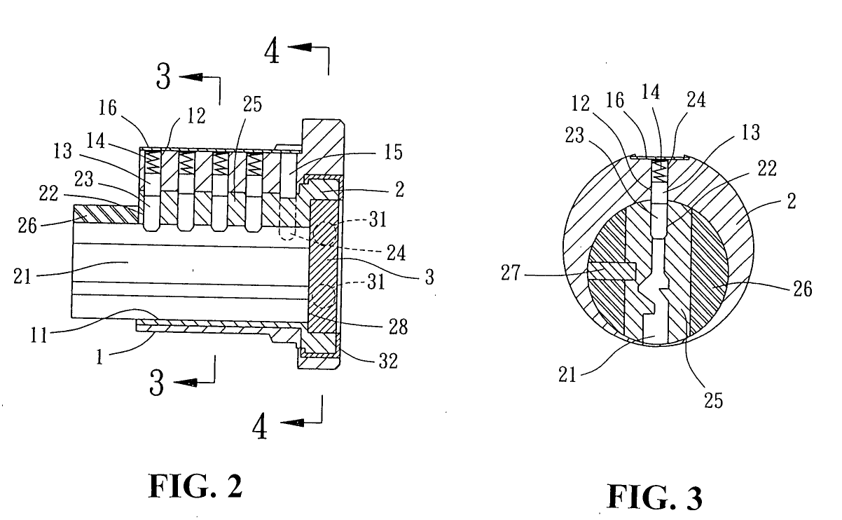

As shown in FIGS. 2 and 3 illustrating embodiments of the present invention, a gate 3 and a spring 31 are primarily disposed in a gate room 28 of a revolver 2, and an open end of the revolver 2 is sealed by a keyhole cover 32 in order to fix the gate 3 and the spring 31 stably in the open end of a key channel 21 of the revolver 2.

Secondly, lower pinballs 23 are disposed in pin holes 22 of the revolver 2, and then the revolver 2 is completely inserted into an axial hole 11 of a lock sleeve 1. Accordingly, a stop pin 15 is hammered into a pin hole 12 of the lock sleeve 1, where the end of the stop pin 15 is embedded into an arc-concaved groove 24 of the revolver 2 to combine and fix the revolve 2 with the axial hole 11 of the lock sleeve 1 firmly.

Moreover, several upper pinballs 13 and springs 14 are disposed in the other pin holes 12 of the lock sleeve 1. Eventually, a cover 16 is disposed on the open ends of the pin holes 12 of the lock sleeve 1 and is pressed hard to fix on the lock sleeve 1 firmly. Thus, the overall structures of the lock core are assembled and finished, as shown in FIG. 2.

As shown in FIGS. 2 and 3, the revolver 2 of the present invention comprises two different metallic materials, where the front part of it is made of cast iron 25 or copper and the rear part of it is made of steel 26. The two different parts are combined and fixed together by a pin 27, as shown in FIG. 3.

The revolver 2 of the present invention utilizes the stronger steel 26 made or heat treatment reinforced steel made rear part-to enhance its structure strength. Thus, burglars are not easy to poke open or destroy the lock core by external force because the steel 26 of the revolver 2 provides strong enough structure to prevent from their stealing behaviors.

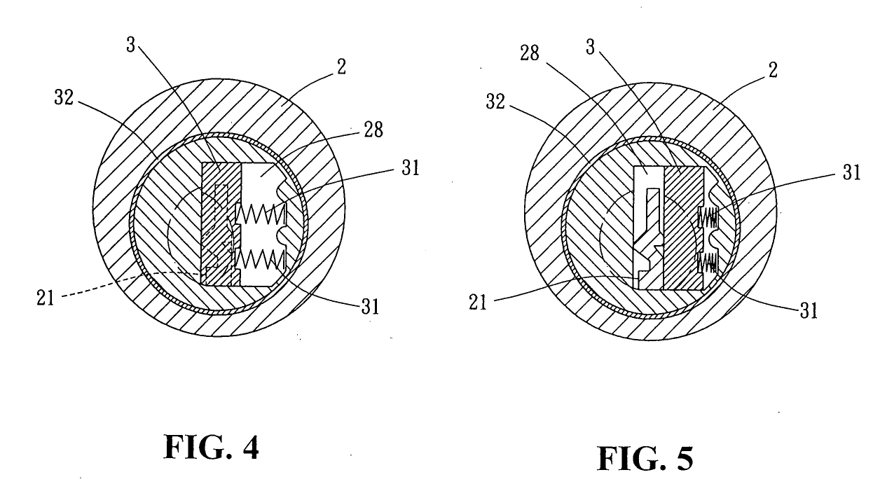

As shown in FIGS. 4 and 5, the open end of the key channel 21 in the revolver 2 of the present invention is always sealed because the gate 3 is constantly pushed by the spring 31 and moved upward to close the key channel 21 open end. Thus, it is able to prevent the key channel 21 from intrusion possibilities of foreign bodies or rain, as shown in FIG. 4.

The lock device is able to be opened provided the key is inserted into the open end of the key channel 21 of the revolver 2, moving the gate 3 aside easily and sliding into the key channel 21 smoothly, and then rotated together with the revolver 2 to unlatch the lock core.

Above all, the present invention relates to the revolver 2, comprising two different metallic materials where the front part of it is made of easily machined cast iron 25 or copper and the rear part of it is made of steel material 26 or heat treatment reinforced steel having firmly strength, so as to increase the lock core structure strength and prevent the destroy or stealing from burglars. Thus, it improves and enhances the burglarproof function of the lock device.

The present invention can practically be utilized in the field, and is in accordance with the patent application requirements of originality and advance. Should the application be passed the required investigations by the officials in the intellectual property office.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A lock core reinforced structure device with two different metallic parts, comprising:
a lock sleeve, a revolver and a gate;
an axial hole formed in the lock sleeve providing insertion of the revolver;
pin holes formed in the axial hole providing disposition of upper pinballs and springs;
a key channel formed in the revolver providing insertion of a key;
pin holes formed in the revolver providing disposition of lower pin balls; and
a front part of the revolver made of cast iron or copper and a rear part of the revolver made of steel material or heat treatment reinforced steel, the revolver formed from combination of these two different metallic parts at least.

2. The device according to claim 1, wherein the lock sleeve includes a pin hole for insertion of a stop pin and an end of the stop pin is able to be embedded into an arc-concaved groove formed on the outer surface of the revolver.

3. The device according to claim 1, wherein the cast iron and the steel of the revolver are combined and fixed by a pin.

4. The device according to claim 1, wherein the cast iron and the steel of the revolver are combined and fixed in one unity by a metal melting technology applied to the joint surfaces of the cast iron and the steel.

5. The device according to claim 1, wherein the arc-concaved groove formed on the revolver provides insertion for the stop pin end to combine the revolver and the lock sleeve, and to limit the rotation angle of the revolver.

6. The device according to claim 1, wherein a gate room formed beside the key channel of the revolver provides disposition of the gate and a spring, and then a keyhole cover is utilized to seal the gate and the spring.

7. The device according to claim 1 or 2, wherein an open end of the pin holes on the lock sleeve is sealed and fixed by a cover.

8. The device according to claim 1 or 6, wherein the gate is constantly pushed and moved upward by the spring to seal the open end of the key channel.
